(19) United States
(12) Patent Application Publication
(10) Pub. No.: US 2024/0346379 A1
(43) Pub. Date: Oct. 17, 2024

(54) ZERO PEEK ROBUSTNESS CHECKS FOR FEDERATED LEARNING

(71) Applicant: The Regents of the University of California, Oakland, CA (US)

(72) Inventors: Zahra Ghodsi, San Diego, CA (US); Mojan Javaheripi, San Diego, CA (US); Nojan Sheybani, San Diego, CA (US); Xinqiao Zhang, San Diego, CA (US); Farinaz Koushanfar, San Diego, CA (US)

(21) Appl. No.: 18/633,905

(22) Filed: Apr. 12, 2024

Related U.S. Application Data
(60) Provisional application No. 63/496,157, filed on Apr. 14, 2023.

(51) Int. Cl. G06N 20/00

(52) U.S. Cl. CPC G06N 20/00

(57) ABSTRACT

A computing system determines a median of a first number of mean values received from a first number of clusters, where each cluster of the first number of clients includes a first plurality of clients. Also, a threshold is determined based on the median, where the threshold applies to model updates. The median and the threshold are broadcast to all clients. Next, one or more clients that fail to provide a proof attesting that their model update is within the threshold of the median are dropped. Then, a second plurality of clients, not including the one or more dropped clients, participate in a final round of secure aggregation. Next, a final aggregate result is obtained, where the final aggregate result is based on the final round of secure aggregation. Then, one or more actions are performed based on the final aggregate result.

### CROSS-REFERENCE TO RELATED APPLICATIONS

The present application claims priority to U.S. Provisional Application No. 63/496,157 filed Apr. 14, 2023, and entitled “ZPROBE: ZERO PEEK ROBUSTNESS CHECKS FOR FEDERATED LEARNING,” and incorporates its disclosure herein by reference in its entirety.

### TECHNICAL FIELD

The present disclosure generally relates to federated learning.

### BACKGROUND

Federated learning (FL) has emerged as a popular paradigm for training a central model on a dataset distributed amongst many parties, by sending model updates and without requiring the parties to share their data. However, model updates in FL can be exploited by adversaries to infer properties of the users' private training data. This lack of privacy prohibits the use of FL in many machine learning applications that involve sensitive data such as healthcare information or financial transactions. Federated learning involves a plurality of users (i.e., clients) providing updates to a central server which trains a model based on these user updates. One challenge is protecting the privacy of individual client updates as the updates can provide information about clients' private training data.

Another challenge in federated learning are Byzantine attacks. A Byzantine attack is when a malicious client sends invalid updates to degrade the model performance. Malicious clients may perform Byzantine attacks by changing the value of their model update to degrade central model performance. Malicious clients may also use inconsistent update values in different steps.

### SUMMARY

In some implementations, a computing system having at least one processor and at least one memory storing instructions that, when executed by the at least one processor, cause operations including determining a median of a first number of mean values received from a first number of clusters, where each cluster of the first number of clients includes a first plurality of clients. Also, a threshold is determined based on the median, where the threshold applies to model updates. The median and the threshold are broadcast to all clients. Next, one or more clients that fail to provide a proof attesting that their model update is within the threshold of the median are dropped. Then, a second plurality of clients, not including the one or more dropped clients, participate in a final round of secure aggregation. Next, a final aggregate result is obtained, where the final aggregate result is based on the final round of secure aggregation. Then, one or more actions are performed based on the final aggregate result.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a computing system, in accordance with some example implementations of the current subject matter;

FIG. 2 illustrates a diagram of steps for performing robust and private aggregation, in accordance with some example implementations of the current subject matter;

FIG. 3 illustrates a formula for a user computing a masked input and a formula for determining a probability of detecting a malicious update, in accordance with some example implementations of the current subject matter;

FIG. 4 illustrates three algorithms that are part of the zPROBE framework, in accordance with some example implementations of the current subject matter;

FIG. 5 illustrates a diagram of detection probability versus number of zero knowledge proof checks, in accordance with some example implementations of the current subject matter;

FIG. 6 illustrates diagrams of studies of performance of various defenses, in accordance with some example implementations of the current subject matter;

FIG. 7 illustrates an example of a process for performing secure aggregation, in accordance with some example implementations of the current subject matter; and

FIG. 8 illustrates an example of a system, in accordance with some example implementations of the current subject matter.

### DETAILED DESCRIPTION

Privacy-preserving federated learning (FL) allows multiple users to jointly train a model with coordination of a central server. The server only learns the final aggregation result, thereby preventing leakage of the users' (private) training data from the individual model updates. However, keeping the individual updates private allows malicious users to perform Byzantine attacks and degrade the model accuracy without being detected. Existing defenses against Byzantine workers rely on robust rank-based statistics (e.g., the median) to find malicious updates. However, implementing privacy-preserving rank-based statistics is nontrivial and unscalable in the secure domain, as it requires the sorting of all individual updates.

This specification presents zPROBE, a novel framework for low overhead, scalable, private, and robust FL in the malicious setting. zPROBE ensures correct behavior from clients, and performs robustness checks on client updates. In some embodiments, a median-based robustness check is implemented that derives a threshold for acceptable model updates using securely computed means over random user clusters. In some embodiments, the thresholds are dynamic and automatically change based on the distribution of the gradients. Notably, the thresholds can be calculated without access to individual user updates or public datasets. The computed thresholds are leveraged to identify and filter malicious clients in a privacy-preserving manner. With a combination of zero-knowledge proofs, verifiable secret sharing, and secure multiparty computation techniques from cryptography, zPROBE provides robustness guarantees without compromising client privacy. zPROBE provides a private robustness defense relying on rank-based statistics with cost that grows sublinearly with respect to the number of clients.

Herein, there is provided a private robustness check that uses high break point rank-based statistics on aggregated model updates. By exploiting randomized clustering, a significant improvement in the scalability of the defense is provided without compromising privacy. The subject matter disclosed herein leverages the derived statistical bounds in zero-knowledge proofs to detect and remove malicious updates without revealing the private user updates. zPROBE enables Byzantine resilient and secure FL. Empirical evaluations demonstrate that zPROBE provides a low overhead solution to defend against state-of-the-art Byzantine attacks while preserving privacy.

Secure aggregation protocols using cryptography may be employed for FL. In these protocols, the server does not learn individual updates, but only a final aggregation with contributions from several users. Hiding individual updates from the server opens up a large attack surface for malicious clients to send invalid updates that compromise the integrity of distributed training.

Byzantine attacks on FL are carried out by malicious clients who manipulate their local updates to degrade the model performance. Several high-fidelity Byzantine-robust aggregation schemes that rely on rank-based statistics (e.g., trimmed mean, median, mean around median, geometric median) require sorting of the individual model updates across users. As such, using these schemes in secure FL is nontrivial and unscalable to large numbers of users since the central server cannot access the (plaintext) value of user updates.

Herein, some of the aforementioned challenges are addressed and there is also disclosed a high break point Byzantine tolerance using rank-based statistics while preserving privacy. In some embodiments, a median-based robustness check is provided that derives a threshold for acceptable model updates using securely computed mean values over random user clusters. As used herein, the term “mean” is defined as an average of a dataset. The “mean” may be calculated for a dataset by dividing the sum of the values of the dataset by the number of values in the dataset.

In some embodiments, the thresholds are dynamic and automatically change based on the distribution of the gradients. Notably, access to individual user updates or public datasets is not needed to establish a defense. The computed thresholds are leveraged to identify and filter malicious clients in a privacy-preserving manner. zPROBE incorporates zero-knowledge proofs to check the behavior of users and identify possible malicious actions, including sending Byzantine updates as well as deviating from the secure aggregation protocol. As such, zPROBE guarantees correct and consistent behavior in the challenging malicious threat model.

Probabilistic optimizations may be incorporated in the design of zPROBE to minimize the overhead of zero-knowledge checks, without compromising security. By co-designing the robustness defense and cryptographic components of zPROBE, a scalable and low overhead solution is provided for private and robust FL. The construction of zPROBE has a cost that grows sub-linearly with respect to the number of clients. In an example, zPROBE performs an aggregation round on ResNet20 over CIFAR-10 with only sub-second client compute time. zPROBE is robust against state-of-the-art Byzantine attacks with 0.5-2.8% higher accuracy compared to prior work on private and robust FL. Additionally, probabilistic optimizations are leveraged to reduce zPROBE overhead without compromising security, resulting in orders of magnitude client runtime reduction compared to a naive implementation.

The following is a brief overview of the cryptographic building blocks used in zPROBE.

Shamir Secret Sharing is a method to distribute a secret s between n parties such that any t shares can be used to reconstruct the secret, but any set of t−1 or fewer shares reveal no information about the secret. Shamir's scheme picks a random (t−1)-degree polynomial P such that P(0)=s. The shares are then created as (i, P(i)), iϵ{1, . . . , n}. With t shares, Lagrange Interpolation can be used to reconstruct the polynomial and obtain the secret.

Zero-Knowledge Proof (ZKP) is a cryptographic primitive between two parties, a prover P and a verifier V, which allows P to convince V that a computation on P's private inputs is correct without revealing the inputs. In an example, the Wolverine ZKP protocol (“Wolverine: fast, scalable, and communication-efficient zero-knowledge proofs for boolean and arithmetic circuit”, Wang et al. In 2021 IEEE Symposium on Security and Privacy (SP), pages 1074-1091. IEEE, 2021) may be used as it is highly efficient for the prover in terms of runtime, memory usage, and communication. In the Wolverine ZKP protocol, value x known by P can be authenticated using information-theoretic message authentication codes (IT-MACs) as follows: assume Δ is a global key sampled uniformly and is known only to V. V is given a uniform key K[x] and P is given the corresponding MAC tag M[x]=K[x]+Δ.x. An authenticated value can be opened (verified) by P sending x and M[x] to V to check whether M[x]?=K[x]+Δ.x. Wolverine represents the computation as an arithmetic or Boolean circuit, for which the secret wire values are authenticated as described. The circuit is evaluated by collaboration between P and V, at the end of which P opens the output indicating the proof correctness.

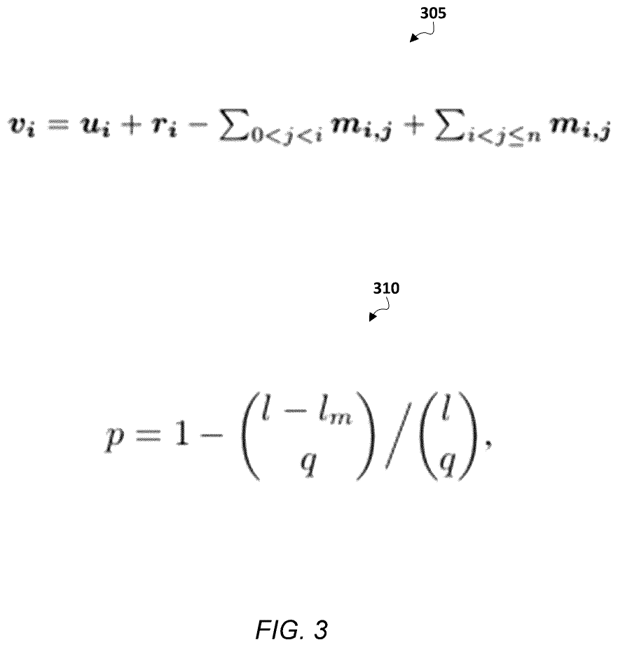

Secure FL Aggregation includes a server and n clients each holding a private vector of model updates with l parameters uϵ [symbol] ^{l}. The server wishes to obtain the aggregate Σᵢ₌₁ⁿuᵢ without learning any of the individual client updates. A secure aggregation protocol may use low-overhead cryptographic primitives such as one-time pads. Each pair of clients (i,j) agree on a random vector m_{i,j}. User i adds m_{i,j} to their input, and user j subtracts it from their input so the masks cancel out when aggregated. To ensure privacy in case of dropout or network delays, each user adds an additional random mask rᵢ. Users then create t-out-of-n Shamir shares of their masks and share them with other clients. User i computes their masked input as shown in formula 305 of FIG. 3.

Once the server receives all masked inputs, the server asks for shares of pairwise masks for dropped users and shares of individual masks for surviving users (but not both) to reconstruct the aggregate value. The framework improves the client runtime complexity to logarithmic scale rather than linear with respect to the number of clients. Note that some secure aggregation protocols assume the clients are semi-honest and do not deviate from the protocol. However, these assumptions are not suitable for a threat model which involves malicious clients. zPROBE provides an aggregation protocol that benefits from speedups and is augmented with zero-knowledge proofs for the challenging malicious setting.

Threat Model. One aim is to protect the privacy of individual client updates as they leak information about clients' private training data. No party should learn any information about a client's update other than the contribution to an aggregate value with inputs from a large number of other clients. Another aim is to protect the central model against Byzantine attacks (i.e., when a malicious client sends invalid updates to degrade the model performance). It may be assumed that the server is a semi-honest server that follows the protocol but tries to learn more information from the received data. It may also be assumed that a portion of clients are malicious (e.g., arbitrarily deviating from the protocol, colluding with each other to cause divergence in the central model, trying to learn the inputs of benign clients). Notably, it may be assumed that the clients may: 1 perform Byzantine attacks by changing the value of their model update to degrade central model performance, 2 use inconsistent update values in different steps, 3 perform the masked update computation in Eq. 305 incorrectly or with wrong values, and 4 use incorrect seed values in generating masks and shares. As described herein, zPROBE is a single-server framework with malicious clients that is resilient against such an extensive attack surface, supports client dropouts, and does not require a public clean dataset. It may be assumed that the data is independent and identically distributed (i.i.d.) among users.

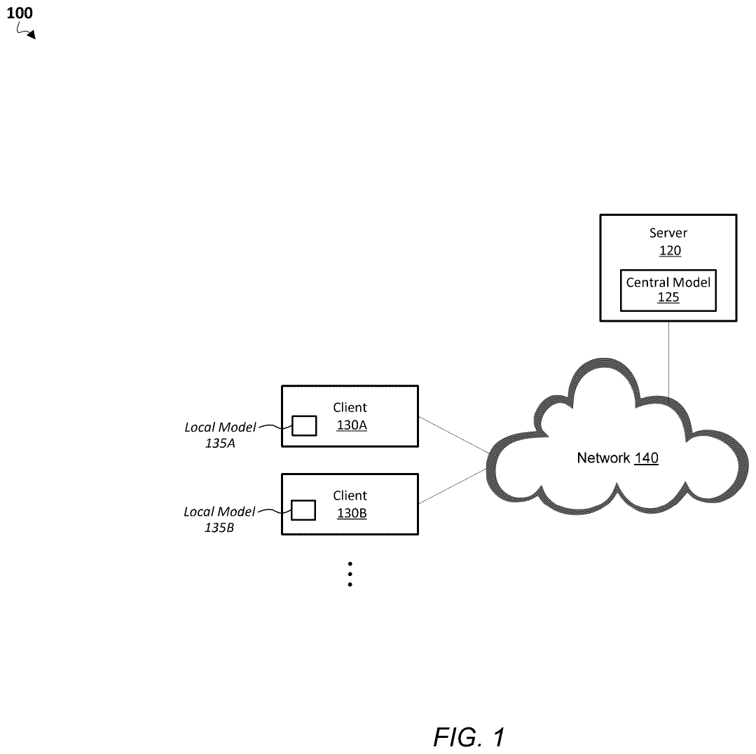

Referring now to FIG. 1, an example of a computing system 100 is depicted, in accordance with some example embodiments. As shown in FIG. 1, the computing system 100 may include at least a server 120 coupled to a plurality of client devices 130A-B via network 140. Generally speaking, the server 120 may provide resources that can be shared among a plurality of tenants (i.e., clients). For example, the server 120 may be configured to provide a variety of services including, for example, software-as-a-service (SaaS), platform-as-a-service (PaaS), infrastructure as a service (IaaS), and/or the like, and these services can be accessed by one or more tenants of the server 120. In the example of FIG. 1, the system 100 includes client devices 130A-B which are representative of any number of clients (i.e., tenants). For example, multitenancy enables multiple end-user devices (e.g., a computer including an application) to access a given server having shared resources via the Internet and/or other type of network or communication link(s).

The server 120 may include resources, such as at least one computer (e.g., a server), data storage, and a network (including network equipment) that couples the computer(s) and storage. The server 120 may also include other resources, such as operating systems, hypervisors, and/or other resources, to virtualize physical resources (e.g., via virtual machines) and provide deployment (e.g., via containers) of applications (which provide services, for example, on the server, and other resources). In the case of a “public” server or cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the server 120 may be part of a “private” cloud platform, in which case the server 120 may be one of an entity's own private servers (e.g., dedicated corporate servers operated and/or owned by the entity). Alternatively, or additionally, the server 120 may be considered part of a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

As shown in FIG. 1, the server 120 and the client devices 130A-B may be communicatively coupled via a network 140. Network 140 may be any wired and/or wireless network including, for example, a public land mobile network (PLMN), a wide area network (WAN), a local area network (LAN), a virtual local area network (VLAN), the Internet, and/or the like. Each client device 130A-B may be a processor-based device including, for example, a smartphone, a tablet computer, a wearable apparatus, a virtual assistant, an Internet-of-Things (IoT) appliance, and/or the like.

In an example, server 120 includes a central model 125 while each client 130A-B has a corresponding local model 135A-B. In an example, central model 125 is a machine learning model and local models 135A-B are local versions of the central machine learning model. In other examples, central model 125 may be any of various other types of models. Each client 130A-B may update its local model 135A-B based on local data, and clients 130A-B may send updates to server 120 to be performed on central model 125. In general, server 120 may build central model 125 to represent local models 135A-B of clients 130A-B which are processing different datasets with the datasets remaining private and confidential.

Server 120 may train central model 125 in a distributed manner based on local models 135A-B in various contexts. In an example, clients 130A-B may include any number of hospitals, with each hospital attempting to enhance their decision making by utilizing the data of other hospitals but without compromising patients' confidential data. In a specific example, each hospital may train a local image recognition model 135A-B for cancer detection based on the hospital's local data. In this specific example, each hospital sends updates to server 120 to train central image recognition model 125 which is more powerful and representative of a wider distribution of patients. The trained version of central image recognition model 125 may then be used by each local hospital, allowing each hospital to benefit from enhanced cancer detection techniques. It should be understood that this is merely one example of an application of training a central model 125 in a distributed manner. Other types of applications are possible and are contemplated. Generally speaking, central model 125 may be trained in various medical applications to enhance therapeutic outcomes and to enable various improved treatments to be applied to patients.

Other applications for training a central model 125 in a distributed manner based on local models 135A-B are also envisioned. For example, an advertising application may be implemented by training a central model 125 which is not allowed to have access to individual user's data. In advertising scenarios, various laws prevent the sharing of user data, but by training central model 125 in a distributed manner based on local models 135A-B, user data can remain anonymous but still be used to enhance central model 125. For example, in a web application, central model 125 may learn the behavior of a group of users without having access to user's private browsing data. In this example, central model 125 may be trained to send advertising messages, generate advertising banners in a graphical user interface (GUI), etc. based on anonymized data from users and based on local training of a plurality of local models 135A-B.

Additionally, central model 125 may be trained in various edge computing applications. In these edge computing applications, each device (e.g., Internet of Things (IoT) device) may not have the computing resources to locally train a large model. Therefore, central model 125 may be utilized in an edge computing application to process data collected from a relatively large number of edge devices. In an example, a data collection network may be deployed with a plurality of edge devices. Each edge device may train a local model 135A-B based on its local data and then send updates of the training to server 120, with the updates being used to train central model 125.

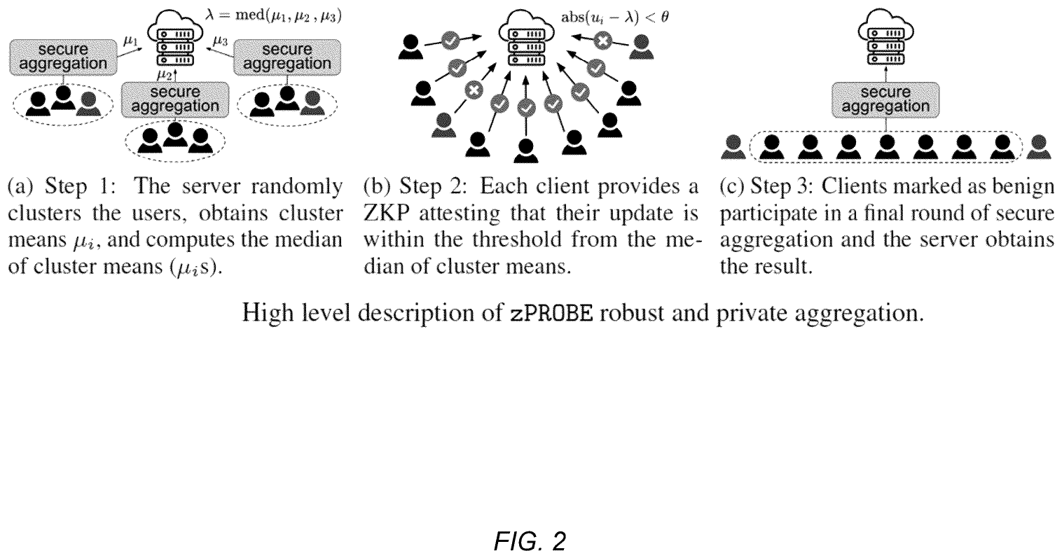

Turning now to FIG. 2, a diagram of steps for performing robust and private aggregation is depicted, in accordance with some embodiments. zPROBE includes two main components, namely, secure aggregation, and robustness establishment. The secure aggregation protocol is intended to mitigate the actions of malicious clients. A proposed method to establish robustness is detailed further below. An adaptive Byzantine defense may be designed that finds the dynamic range of acceptable model updates per iteration. Using the derived bounds on model updates, a secure range check is devised on client updates to filter Byzantine attackers. The robustness check is privacy-preserving and scalable to many clients.

The proposed robust and private aggregation is performed in three steps as illustrated in FIG. 2. First, the server (e.g., server 120 of FIG. 1) clusters the clients randomly into c clusters. Each cluster cⱼ then performs zPROBE's secure aggregation protocol. The server obtains the aggregate value aⱼ and the mean μⱼ=aⱼ/|cⱼ| for each cluster in plaintext. In the second step, the server uses the median λ of all cluster means to compute a threshold Θ for model updates. As used herein, the term “median” is defined as a middle number in a sorted ascending or descending list of numbers. The median represents the midpoint of a dataset of numbers. The values of median λ and threshold Θ are public, and broadcasted by the server to all clients. Each client i then provides a zero-knowledge proof attesting that their update is within the threshold from the median (i.e., abs(uᵢ−λ)<Θ). This ensures that clients are not performing Byzantine attacks on the central model (item 1 in the threat model). Users that fail to provide the proof are considered malicious and treated as dropped. The remaining users participate in a round of zPROBE secure aggregation and the server obtains the final aggregate result. It is noted that the final round of secure aggregation may also include correctness ZKP.

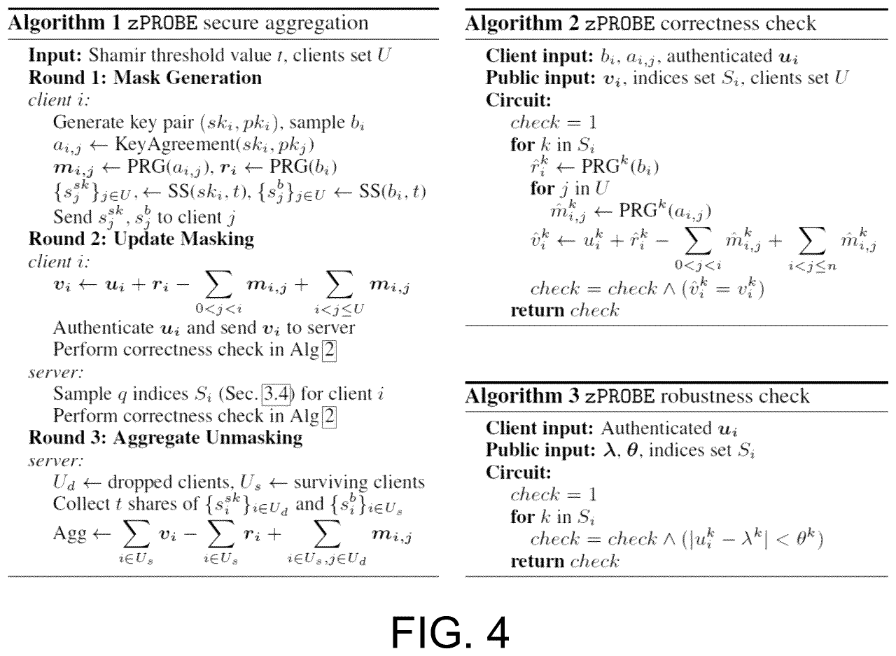

Turning now to FIG. 4, three algorithms that are part of the zPROBE framework are depicted, in accordance with one or more embodiments of the current subject matter. As shown in FIG. 4, Algorithm (Alg.) 1, or zPROBE Secure Aggregation, shows the detailed steps for zPROBE's secure aggregation for n clients, which consists of three rounds. In the first round, each client i generates a key pair (skᵢ, pkᵢ), samples a random seed bᵢ, and performs a key agreement protocol with client j to obtain a shared seed a_{i,j}. The seeds are used to generate individual and pairwise masks using a pseudorandom generator (PRG). The AES block cipher in the counter mode (CTR) may be used as the PRG. Each client then creates t-out-of-n Shamir shares (SS) of skᵢ and bᵢ, and sends one share of skᵢ and bᵢ to every other client.

In the second round, each client uses the masks generated in round one to compute masked updates according to Equation 305 (of FIG. 3), which are then sent to the server. All clients authenticate their update, according to the ZKP authentication protocol. This ensures that clients use consistent update values across different steps (item 2 in the threat model). In addition, each client proves, in zero-knowledge, that their sent value vᵢ is correctly computed as shown in Alg. 2. Specifically, the circuit that is evaluated in zero-knowledge expands the generated seeds to masks, and computes the masked update according to Equation 305. The value of check is then opened by the client, and the server verifies that check=1. This ensures that the masks are correctly generated from seeds, and that the masked update is correctly computed (item 3 in the threat model). Users that fail to provide the proof are marked as dropped in the next round and their update is not incorporated in aggregation.

Moreover, optimizations are provided as noted below in which the server is allowed to derive a bound q, for the number of parameter updates to be checked, such that the probability of detecting Byzantine updates is higher than a predefined rate. The server samples q random parameters from client i, and performs the update correctness check (Alg. 2). It is noted that clients are not motivated to modify the seeds for creating masks, since this results in uncontrollable, out-of-bound errors that can be easily detected by the server (item 4 in the threat model).

In round 3, the server performs unmasking by asking for shares of skᵢ for dropped users and shares of bᵢ for surviving users, which are then used to reconstruct the pairwise and individual masks for dropped and surviving users, respectively. The server is then able to obtain the aggregate result.

zPROBE Complexity. In this section, a complexity analysis of zPROBE runtime is presented with respect to number of clients n (with k=log n) and model size l. Client: Each client computation consists of (1) performing key agreements with O(k), (2) generating pairwise masks with O(k.l), (3) creating t-out-of-k Shamir shares with O(k²), (4) performing correctness checks of Alg. 2 with O(k.l), and (5) performing robustness checks of Alg. 3 with O(l). The complexity of client compute is therefore O (log² n+1. log n). Server. The server computation consists of (1) reconstructing t-out-of-k shamir shares with O(n.k²), (2) generating pairwise masks for dropped out clients with O(n.k.l), (3) performing correctness checks of Alg. 2 with O(n.l), and (5) performing robustness checks of Alg. 3 with O(n.l). The overall complexity of server compute is thus O(n.log² n+n.l. log n).

Deriving Dynamic Bounds. To identify the malicious gradient updates, the valid range for acceptable gradients is adaptively determined per iteration. In this context, acceptable gradients are those that do not harm the central model's convergence when included in the gradient aggregation. To successfully identify such gradients, the underlying assumption is that benign model updates are in the majority while harmful Byzantine updates form a minority of outlier values. In the presence of outliers, the median can serve as a reliable baseline for in-distribution values.

In the secure FL setup, the true value of the individual user updates is not revealed to the server. Calculating the median on the masked user updates is therefore nontrivial since it requires sorting the values which incurs extremely high overheads in a secure domain. This challenge is circumvented by forming clusters of users, where secure aggregation can be used to efficiently compute the average of their updates. The secure aggregation abstracts out the user's individual updates, but reveals the final mean value for each cluster {μ₁, u₂, . . . , μ_{c}} to the server. The server can thus easily compute the median (λ) on the mean of clusters in plaintext.

Using the Central Limit Theorem for Sums, the cluster means follow a normal distribution

$$𝒩 ( {{μ ,}^{\text{?}}}_{\text{?}} {\frac{1}{\sqrt{{n}_{a}}}}_{\text{?}} σ )$$

$$\text{?} \text{indicates text missing or illegible when filed}$$

where μ and σ denote the mean and standard deviation of the original model updates and n_{c} is the cluster size. The original model updates also follow a normal distribution assuming i.i.d. data. The standard deviation of the cluster means (σ_{μ}) may be used as a distance metric for marking outlier updates. The distance is measured from the median of means λ, which serves as an acceptable model update drawn from

$$𝒩 ( μ , \frac{1}{\sqrt{\text{?}}} σ ) .$$

$$\text{?} \text{indicates text missing or illegible when filed}$$

For a given update uᵢ, Byzantine behavior is detected by checking |uᵢ−λ|<Θ, where

$$θ = η . {σ}_{μ} = \text{?} σ .$$

$$\text{?} \text{indicates text missing or illegible when filed}$$

The value of η can be tuned based on cluster size (n_{c}) and the desired statistical bounds on the distance, in terms of standard deviation, from the mean of benign model updates.

Secure Robustness Check. ZKPs are leveraged to ensure robustness against malicious clients that send invalid updates, without compromising clients' privacy. An implementation of ZKP relies on robustness metrics such as the median of cluster means λ and the robustness threshold Θ. Clients (P) prove to the server (V) that their updates comply with the robustness range check.

During the aggregation round in step 1, the clients authenticate their private updates, and the authenticated value is used in steps 2 and 3. This ensures that consistent values are used across steps and that clients do not change their update after the clients learn λ and Θ to fit within the robustness threshold. In step 2, the server makes λ and Θ public. Within the ZKP, each of the client's updates uᵢ are used in a Boolean circuit determining if |uᵢ−λ|<Θ as outlined in Alg. 3. Invalid model updates that fail the range check will be dropped from the final aggregation round.

Probabilistic Optimizations. This section provides statistical bounds on the number of required checks to accurately detect malicious clients. Using the derived bounds, the framework is optimized for minimum overhead, thereby ensuring scalability to large models.

Malicious clients can compromise their update, by sending updates with distance margins larger than the tolerable threshold Θ, or sending incorrect masked updates (according to equation 305). It is assumed that the malicious party has exactly lₘ model parameter updates, out of the total l, that have been compromised. The probability of detecting a malicious update is equivalent to finding at least one compromised parameter gradient as shown in equation 310 of FIG. 3. In equation 310, q denotes the number of per-user ZKP checks on model updates. The above formulation confirms that it is indeed not necessary to perform ZKP checks on all parameter updates within the model. Rather, q can be easily computed via Equation 310, such that the probability of detecting a compromised update is higher than a predefined rate: p>1−δ.

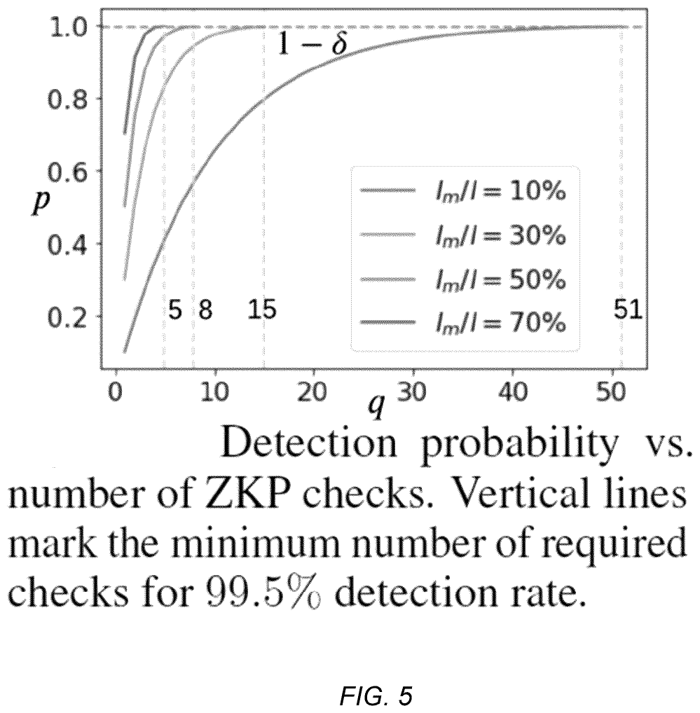

FIG. 5 shows the probability of detecting malicious users versus number of ZKP checks for a model with l=60K parameters. As seen, zPROBE guarantees a failure rate lower than δ=0.005 with very few ZKP checks. Note that malicious users are incentivized to attack a high portion of updates to increase their effect on the aggregated model's accuracy. Equation 310 may be leveraged to derive the required number of correctness and robustness checks as described in Alg. 2 and Alg. 3. For each check, the server computes the bound q, then samples q random indices from model parameters for each client. The clients then provide ZKPs for the selected set of parameter indices.

Defense Parameter. The zPROBE robustness check enforces a threshold Θ on the distance from the median of cluster means, which is formulated as a multiplicative of the standard deviation (SD) of cluster mean updates Θ=η·σ_{μ}. Using the relationship between the SD of the cluster means and the individual model updates

$${(}^{\text{?}} {{σ}_{μ}}_{\text{?}} = {\frac{1}{\sqrt{n}}}_{\text{?}} σ ) ,$$

$$\text{?} \text{indicates text missing or illegible when filed}$$

the strictness of the outlier detection may be controlled by varying η. For example, following the normal distribution of the (i.i.d.) updates, setting

$$\frac{η}{\sqrt{n}} = 2$$

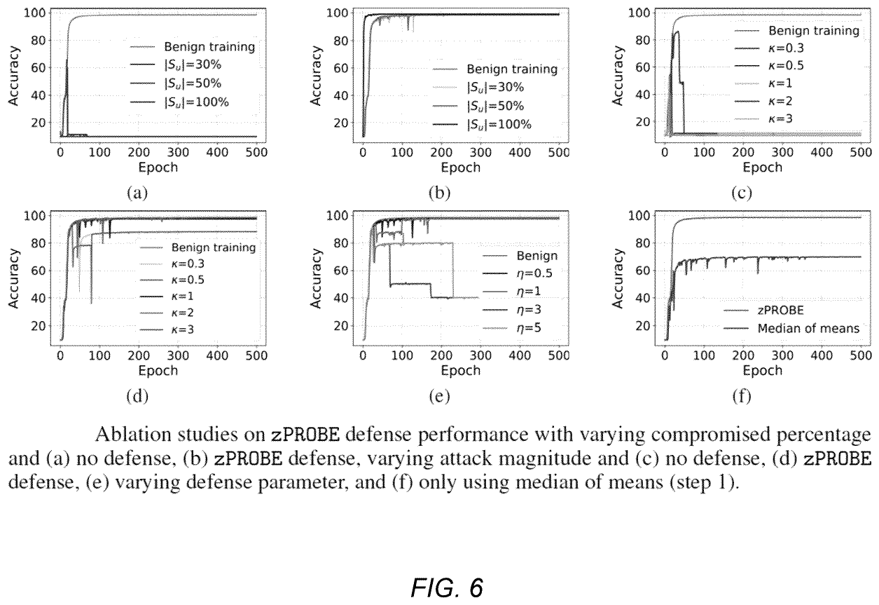

would allow ˜95.4% of the update values to pass the threshold. The effect of η on the robustness performance is investigated in FIG. 6(e). Setting a strict bound using smaller η, successfully removes all malicious updates. This conservative robustness check mimics the defense strategy used in Trimmed-mean family of defenses.

zPROBE Aggregation. As shown in FIG. 2, zPROBE uses the median of per-cluster means (in plaintext) to extract a threshold, which is then used in step 2 to filter out malicious clients. Rather than performing steps 2 and 3 of zPROBE, an alternative robust aggregation rule may directly use the median value to update the global model. Nevertheless, merely using the median for the final aggregation ignores beneficial updates by benign users. This, in turn, leads to a drastic accuracy degradation of 28.57% compared to zPROBE which includes all gradients that pass the threshold.

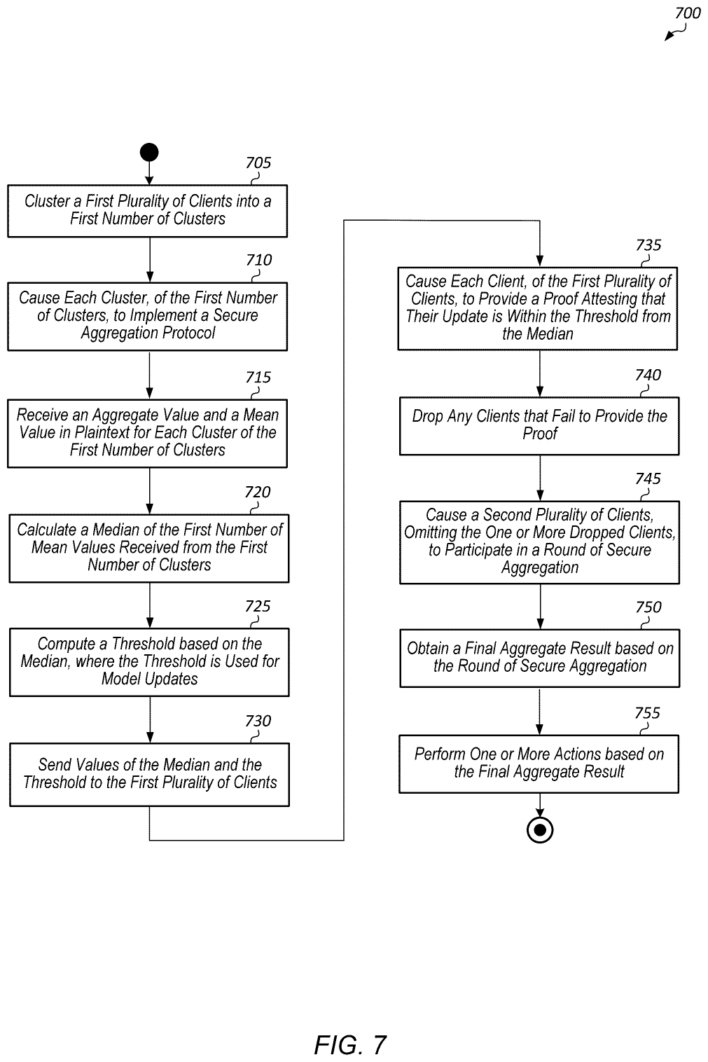

Referring now to FIG. 7, a process is depicted for performing secure aggregation, in accordance with one or more embodiments of the current subject matter. A server clusters a first plurality of clients into a first number of clusters (block 705). It is noted that the server may randomly cluster the first plurality of clients into the first number of clusters in block 705. The number of clusters in the first number of clusters may vary according to the embodiment. Also, the number of clients per cluster may also vary according to the embodiment.

Next, the server causes each cluster, of the first number of clusters, to implement a secure aggregation protocol (block 710). Then, the server receives an aggregate value and a mean value in plaintext for each cluster of the first number of clusters (block 715). Next, the server calculates a median of the first number of mean values received from the first number of clusters (block 720). Then, the server computes a threshold based on the median, where the threshold applies to model updates (block 725). In an example, the threshold Θ is formulated as a multiplicative of the standard deviation (SD) of cluster mean updates Θ=η·σ_{μ}. Using the relationship between the SD of the cluster means and the individual model updates

$${(}^{\text{?}} {{σ}_{μ}}_{\text{?}} = {\frac{1}{\sqrt{n}}}_{\text{?}} σ ) ,$$

$$\text{?} \text{indicates text missing or illegible when filed}$$

the strictness of the outlier detection may be controlled by varying η. For example, following the normal distribution of the (i.i.d.) updates, setting

$$\frac{η}{\sqrt{n}} = 2$$

would allow ˜95.4% of the update values to pass the threshold.

Next, the server sends the median and the threshold to the first plurality of clients (block 730). In other words, the server broadcasts values of the median and the threshold to the first plurality of clients in block 730. Then, the server causes each client, of the first plurality of clients, to provide a proof (e.g., a zero-knowledge proof) attesting that their update is within the threshold from the median (block 735). Next, the server drops any clients that fail to provide the proof (block 740). Then, the server causes a second plurality of clients, omitting the one or more dropped clients, to participate in a round of secure aggregation (block 745). Next, the server obtains a final aggregate result based on the round of secure aggregation (block 750). Then, the server performs one or more actions based on the final aggregate result (block 755). After block 755, method 700 may end. In an example, the one or more actions performed based on the final aggregate result may include training a machine learning model with the final aggregate result to generate a trained machine learning model.

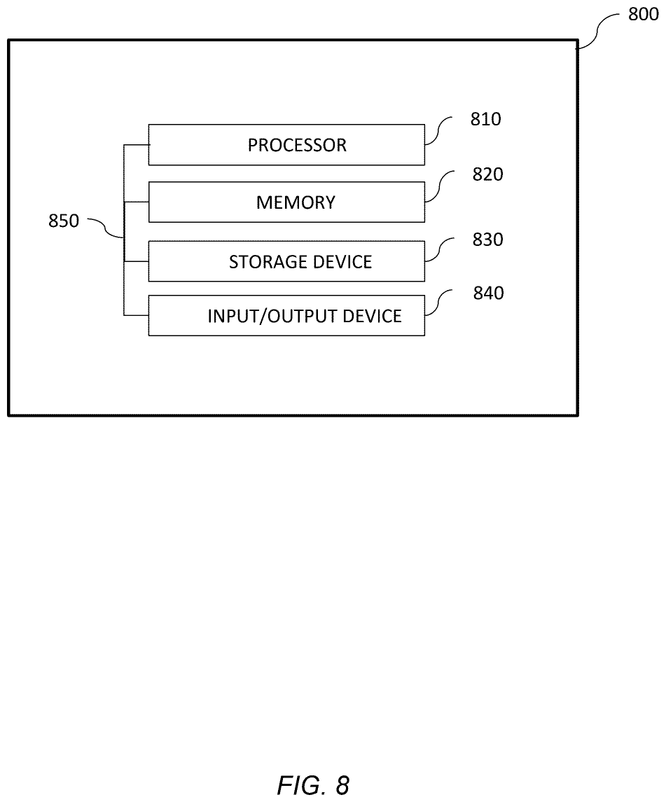

In some implementations, the current subject matter may be configured to be implemented in a system 800, as shown in FIG. 8. For example, the operations of ZProbe (or one or more if not all of the aspects of ZProbe) may be at least in part physically comprised on system 800. To illustrate further system 800 may further an operating system, a hypervisor, and/or other resources, to provide virtualize physical resources (e.g., via virtual machines). The system 800 may include a processor 810, a memory 820, a storage device 830, and an input/output device 840. Each of the components 810, 820, 830 and 840 may be interconnected using a system bus 850. The processor 810 may be configured to process instructions for execution within the system 800. In some implementations, the processor 810 may be a single-threaded processor. In alternate implementations, the processor 810 may be a multi-threaded processor. The processor 810 may be further configured to process instructions stored in the memory 820 or on the storage device 830, including receiving or sending information through the input/output device 840. The memory 820 may store information within the system 800. In some implementations, the memory 820 may be a computer-readable medium. In alternate implementations, the memory 820 may be a volatile memory unit. In yet some implementations, the memory 820 may be a non-volatile memory unit. The storage device 830 may be capable of providing mass storage for the system 800. In some implementations, the storage device 830 may be a computer-readable medium. In alternate implementations, the storage device 830 may be a floppy disk device, a hard disk device, an optical disk device, a tape device, non-volatile solid state memory, or any other type of storage device. The input/output device 840 may be configured to provide input/output operations for the system 800. In some implementations, the input/output device 840 may include a keyboard and/or pointing device. In alternate implementations, the input/output device 840 may include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, articles, and/or articles of manufacture depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computing system comprising: at least one processor; at least one memory storing instructions that, when executed by the at least one processor, cause operations comprising: determining a median of a first number of mean values received from a first number of clusters, wherein each cluster of the first number of clients includes a first plurality of clients; determining a threshold based on the median, wherein the threshold applies to model updates; sending the median and the threshold to each client in the first number of clusters; dropping one or more clients that fail to provide a proof attesting that a corresponding model update is within the threshold of the median; causing a second plurality of clients, not including the one or more dropped clients, to participate in a final round of secure aggregation; obtaining a final aggregate result based on the final round of secure aggregation; and performing one or more actions based on the final aggregate result.

Example 2: The computing system of Example 1, wherein the operations further comprise performing a range check on model updates, wherein invalid model updates that fail the range check are dropped from the final round of secure aggregation.

Example 3: The computing system of any of Examples 1-2, wherein the operations further comprise: randomly clustering the second plurality of clients into the first number of clusters; and causing each cluster, of the first number of clusters, to implement a secure aggregation protocol.

Example 4: The computing system of any of Examples 1-3, wherein the operations further comprise receiving an aggregate value and a mean value in plaintext for each cluster of the first number of clusters.

Example 5: The computing system of any of Examples 1-4, wherein the threshold is computed based on a standard deviation of cluster mean updates.

Example 6: The computing system of any of Examples 1-5, wherein the operations further comprise determining a dynamic range of acceptable model updates for each iteration independently from other iterations.

Example 7: The computing system of any of Examples 1-6, wherein the operations further comprise determining a bound for a number of model updates to be checked.

Example 8: The computing system of any of Examples 1-7, wherein the bound is determined so that a probability of detecting malicious updates is higher than a predefined rate.

Example 9: The computing system of any of Examples 1-8, wherein the one or more actions performed based on the final aggregate result comprise training a machine learning model with the final aggregate result to generate a trained machine learning model.

Example 10: The computing system of any of Examples 1-9, wherein the trained machine learning model is a central version of the machine learning model, and wherein each client of the first number of clusters is training a local version of the machine learning model.

Example 11: A computer-implemented method comprising: determining a median of a first number of mean values received from a first number of clusters, wherein each cluster of the first number of clients includes a first plurality of clients; determining a threshold based on the median, wherein the threshold applies to model updates; sending the median and the threshold to each client in the first number of clusters; causing each client in the first number of clusters to provide a proof attesting that a corresponding model update is within the threshold of the median; allowing a second plurality of clients to participate in a final round of secure aggregation, wherein the second plurality of clients comprise client who providing the proof attesting that the corresponding model update is within the threshold of the median; obtaining a final aggregate result based on the final round of secure aggregation; and performing one or more actions based on the final aggregate result.

Example 12: The computer-implemented method of Example 11, further comprising performing a range check on model updates, wherein invalid model updates that fail the range check are dropped from the final round of secure aggregation.

Example 13: The computer-implemented method of any of Examples 11-12, further comprising: randomly clustering the second plurality of clients into the first number of clusters; and causing each cluster, of the first number of clusters, to implement a secure aggregation protocol.

Example 14: The computer-implemented method of any of Examples 11-13, further comprising receiving an aggregate value and a mean value in plaintext for each cluster of the first number of clusters.

Example 15: The computer-implemented method of any of Examples 11-14, further comprising determining the threshold based on a standard deviation of a plurality of mean values received from the first number of clusters.

Example 16: The computer-implemented method of any of Examples 11-15, further comprising determining a dynamic range of acceptable model updates for each iteration independently from other iterations.

Example 17: The computer-implemented method of any of Examples 11-16, further comprising determining a bound for how many model updates should be verified.

Example 18: The computer-implemented method of any of Examples 11-17, wherein the bound is determined so that a probability of detecting malicious updates is higher than a predetermined rate.

Example 19: The computer-implemented method of any of Examples 11-18, wherein the one or more actions performed based on the final aggregate result comprise training a machine learning model with the final aggregate result to generate a trained machine learning model.

Example 20: A non-transitory computer readable medium storing instructions, which when executed by at least one data processor, result in operations comprising: determining a median of a first number of mean values received from a first number of clusters, wherein each cluster of the first number of clients includes a first plurality of clients; determining a threshold based on the median, wherein the threshold applies to model updates; sending the median and the threshold to all clients in the first number of clusters; allowing a second plurality of clients that provide a proof attesting that a corresponding model update is within the threshold of the median to participate in a final round of secure aggregation; obtaining a final aggregate result based on the final round of secure aggregation; and performing one or more actions based on the final aggregate result.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computing system comprising:
at least one processor;
at least one memory storing instructions that, when executed by the at least one processor, cause operations comprising:
determining a median of a first number of mean values received from a first number of clusters, wherein each cluster of the first number of clients includes a first plurality of clients;
determining a threshold based on the median, wherein the threshold applies to model updates;
sending the median and the threshold to each client in the first number of clusters;
dropping one or more clients that fail to provide a proof attesting that a corresponding model update is within the threshold of the median;
causing a second plurality of clients, not including the one or more dropped clients, to participate in a final round of secure aggregation;
obtaining a final aggregate result based on the final round of secure aggregation; and
performing one or more actions based on the final aggregate result.

2. The computing system of claim 1, wherein the operations further comprise performing a range check on model updates, wherein invalid model updates that fail the range check are dropped from the final round of secure aggregation.

3. The computing system of claim 1, wherein the operations further comprise:
randomly clustering the second plurality of clients into the first number of clusters; and
causing each cluster, of the first number of clusters, to implement a secure aggregation protocol.

4. The computing system of claim 3, wherein the operations further comprise receiving an aggregate value and a mean value in plaintext for each cluster of the first number of clusters.

5. The computing system of claim 1, wherein the threshold is computed based on a standard deviation of cluster mean updates.

6. The computing system of claim 1, wherein the operations further comprise determining a dynamic range of acceptable model updates for each iteration independently from other iterations.

7. The computing system of claim 1, wherein the operations further comprise determining a bound for a number of model updates to be checked.

8. The computing system of claim 7, wherein the bound is determined so that a probability of detecting malicious updates is higher than a predefined rate.

9. The computing system of claim 1, wherein the one or more actions performed based on the final aggregate result comprise training a machine learning model with the final aggregate result to generate a trained machine learning model.

10. The computing system of claim 9, wherein the trained machine learning model is a central version of the machine learning model, and wherein each client of the first number of clusters is training a local version of the machine learning model.

11. A computer-implemented method comprising:
determining a median of a first number of mean values received from a first number of clusters, wherein each cluster of the first number of clients includes a first plurality of clients;
determining a threshold based on the median, wherein the threshold applies to model updates;
sending the median and the threshold to each client in the first number of clusters;
causing each client in the first number of clusters to provide a proof attesting that a corresponding model update is within the threshold of the median;
allowing a second plurality of clients to participate in a final round of secure aggregation, wherein the second plurality of clients comprise client who providing the proof attesting that the corresponding model update is within the threshold of the median;
obtaining a final aggregate result based on the final round of secure aggregation; and
performing one or more actions based on the final aggregate result.

12. The computer-implemented method of claim 11, further comprising performing a range check on model updates, wherein invalid model updates that fail the range check are dropped from the final round of secure aggregation.

13. The computer-implemented method of claim 11, further comprising:
randomly clustering the second plurality of clients into the first number of clusters; and
causing each cluster, of the first number of clusters, to implement a secure aggregation protocol.

14. The computer-implemented method of claim 11, further comprising receiving an aggregate value and a mean value in plaintext for each cluster of the first number of clusters.

15. The computer-implemented method of claim 14, further comprising determining the threshold based on a standard deviation of a plurality of mean values received from the first number of clusters.

16. The computer-implemented method of claim 11, further comprising determining a dynamic range of acceptable model updates for each iteration independently from other iterations.

17. The computer-implemented method of claim 11, further comprising determining a bound for how many model updates should be verified.

18. The computer-implemented method of claim 17, wherein the bound is determined so that a probability of detecting malicious updates is higher than a predetermined rate.

19. The computer-implemented method of claim 11, wherein the one or more actions performed based on the final aggregate result comprise training a machine learning model with the final aggregate result to generate a trained machine learning model.

20. A non-transitory computer readable medium storing instructions, which when executed by at least one data processor, result in operations comprising:
determining a median of a first number of mean values received from a first number of clusters, wherein each cluster of the first number of clients includes a first plurality of clients;
determining a threshold based on the median, wherein the threshold applies to model updates;
sending the median and the threshold to all clients in the first number of clusters;
allowing a second plurality of clients that provide a proof attesting that a corresponding model update is within the threshold of the median to participate in a final round of secure aggregation;
obtaining a final aggregate result based on the final round of secure aggregation; and
performing one or more actions based on the final aggregate result.
